(19) United States
(12) Patent Application Publication
(10) Pub. No.: US 2012/0088204 A1
(43) Pub. Date: Apr. 12, 2012

(54) LIGHT THERAPY DEVICE

(75) Inventors: Ming-Hua Ho, Taipei City (TW); Lu-Sheng Hong, Taipei City (TW); Hsian-Shin Yu, Xindian City (TW)

(73) Assignees: Ming-Hua HO, Taipei City (TW); Jetts Technology Co., Ltd., Taipei (TW); Lu-Sheng HONG, Taipei City (TW)

(21) Appl. No.: 12/901,654

(22) Filed: Oct. 11, 2010

(51) Int. Cl. A61C 3/00

(52) U.S. Cl. 433/29

(57) ABSTRACT

A light therapy device includes a main body, a light-emitting portion and a power supply unit. The light-emitting portion is disposed on the main body. The light-emitting portion has a first light source. The first light source provides light with a specific wavelength and with an energy ranged from 0.01 J/cm² to 10 J/cm². The power supply unit is electrically connected to the main body, and is configured for providing the light-emitting portion with electric power. The light therapy device is used to irradiate teeth and periodontal cells, which can accelerate regeneration of teeth bone cells and gum tissues and inhibit bacteria, thereby achieving the therapeutic effect.

### FIELD OF THE INVENTION

The present invention relates to light therapy devices, and more particularly to a light therapy device used for treating periodontal diseases.

### BACKGROUND OF THE INVENTION

Many modern people suffer from periodontal diseases. Generally, periodontal tissues include gum and alveolar bone, that is, periodontal tissues are the structure around a tooth. Its role is like a foundation of a building, and the tooth is like a main body of the building. The periodontal diseases can be compared to the foundation breaking down, although the main body of the building has no problem, the building may collapse at any moment because continuous loss of debris leads to stagger of the building.

Periodontal diseases can be substantially divided into two stages in accordance with the severity. In the initial stage, the periodontal disease is gingivitis, that is, inflammation is confined to the gum, which usually refers to tissues around the teeth turn very red or even swell. When the sufferer brushes his/her teeth, the swelling gum may be bloody. If the gingivitis is not treated, the gingivitis will be easily converted to periodontitis (i.e., periodontal disease) after a long time. By the medical research, it is known that, the periodontal diseases are mainly caused by plaques in tooth necks. When the plaques begin to release toxins, the supporting tissues around teeth will be violated by the toxins. These bacteria causing the periodontal disease multiply in large quantities, which will result in pain of the gum. When the periodontal disease become very serious, the gum will fester. If there is not any treatment, the periodontal disease will continuously worsen, and the bone of teeth will gradually lose. As a result, the teeth begin to shake, and then fall off one by one.

In traditional dental technology for treating periodontal diseases, substantially, the purpose is to reduce oral bacteria and decrease inflammation phenomenon of periodontal tissues (gum, periodontal ligament and so on). Generally, oral bacteria are scraped off, and antibiotics and anti-inflammatory drugs are used. A method for scraping off oral bacteria is to use a laser. Since the laser with a high energy is selected, teeth or periodontal tissues may be damaged when treating. After the traditional treatment, because of detumescence of the gum, the gum will atrophy, teeth root will be exposed, and the teeth are sensitive to cold and heat and so on.

### SUMMARY OF THE INVENTION

Therefore, the object of the present invention is to provide a light therapy device. The light therapy device has light with a specific wavelength and a specific energy. The light is used to irradiate teeth and periodontal cells. The light stimulation can accelerate regeneration of the teeth bone cells and gum, and inhibit the activity of periodontal bacteria, so as to achieve a therapeutic effect.

To achieve at least one of the above-mentioned advantages, the present invention provides a light therapy device which includes a main body, a light-emitting portion and a power supply unit. The light-emitting portion is disposed on the main body. The light-emitting portion has a first light source. The first light source provides light with a specific wavelength and with an energy ranged from 0.01 joule/square centimeters (J/cm²) to 10 J/cm². The power supply unit is electrically connected to the main body, and is configured for providing the light-emitting portion with electric power.

In one embodiment of the present invention, the first light source is a light emitting diode.

In one embodiment of the present invention, the first light source provides light with a wavelength ranged from 650 nm to 800 nm and with an energy ranged from 0.2 J/cm² to 10 J/cm².

In one embodiment of the present invention, the first light source provides light with a wavelength ranged from 650 nm to 700 nm and with an energy ranged from 3 J/cm² to 8 J/cm².

In one embodiment of the present invention, the first light source provides light with a wavelength ranged from 550 nm to 650 nm and with an energy ranged from 0.2 J/cm² to 10 J/cm².

In one embodiment of the present invention, the first light source provides light with a wavelength ranged from 560 nm to 630 nm and with an energy ranged from 3 J/cm² to 8 J/cm².

In one embodiment of the present invention, the first light source provides light with a wavelength ranged from 385 nm to 445 nm.

In one embodiment of the present invention, the first light source provides light with a wavelength ranged from 390 nm to 420 nm and with an energy ranged from 0.2 J/cm² to 6 J/cm².

In one embodiment of the present invention, the first light source provides infrared radiation with a wavelength ranged from 800 nm to 950 nm and with an energy ranged from 0.01 J/cm² to 2 J/cm².

In one embodiment of the present invention, the light-emitting portion further comprises a second light source, the second light source provides light with an energy ranged from 5 J/cm² to 20 J/cm².

In one embodiment of the present invention, the second light source is a light emitting diode.

In one embodiment of the present invention, the light-emitting portion is a light emitting diode capable of emitting composite light, so as to provide the first light source and the second light source.

In one embodiment of the present invention, the second light source provides light with a wavelength ranged from 650 nm to 800 nm and with an energy ranged from 10 J/cm² to 20 J/cm².

In one embodiment of the present invention, the second light source provides light with a wavelength ranged from 550 nm to 650 nm.

In one embodiment of the present invention, the second light source provides light with a wavelength ranged from 385 nm to 445 nm.

In one embodiment of the present invention, the light therapy device further comprises a photodynamic antimicrobial disposed on the main body.

In one embodiment of the present invention, the photodynamic antimicrobial comprises Toluidine Blue O (TBO), porphyrins, porphyrin-derivatives, chlorine, chlorine-derivatives, 5-aminolevulinic acid (ALA), 3,6-bis(1-methyl-4-vinylpyridinium)carbazole diiodide (BMVC), MBVC-derivatives, methylene blue (MB), actinomycin, hypocrellin, hypocrellin-derivatives, phycocyanin or phycocyanin-derivative.

In one embodiment of the present invention, the main body has a long-handled, U-shaped or sheet-shaped structure.

The light therapy device of the present invention can provide light with a specific wavelength and energy. The use of the light therapy device for treating periodontal diseases, not only can decrease the damage to teeth and periodontal cells, but also can accelerate regeneration of teeth bone cells and gum tissues and inhibit bacteria, thereby increasing the therapeutic effect.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic, structure view of a light therapy device of an embodiment of the present invention.

FIG. 2 is a schematic view of a light-emitting portion of a light therapy device of another embodiment of the present invention.

FIG. 3 is a schematic, structure view of a main body of a light therapy device of another embodiment of the present invention.

FIG. 4 is a schematic, structure view of a main body of a light therapy device of another embodiment of the present invention.

FIG. 5 is a schematic, structure view of a main body of a light therapy device of another embodiment of the present invention.

FIG. 6 is an experiment data based on activity changes of periodontal cells stimulated by light.

FIG. 7 is an experiment data based on activity changes of periodontal bacteria stimulated by light.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

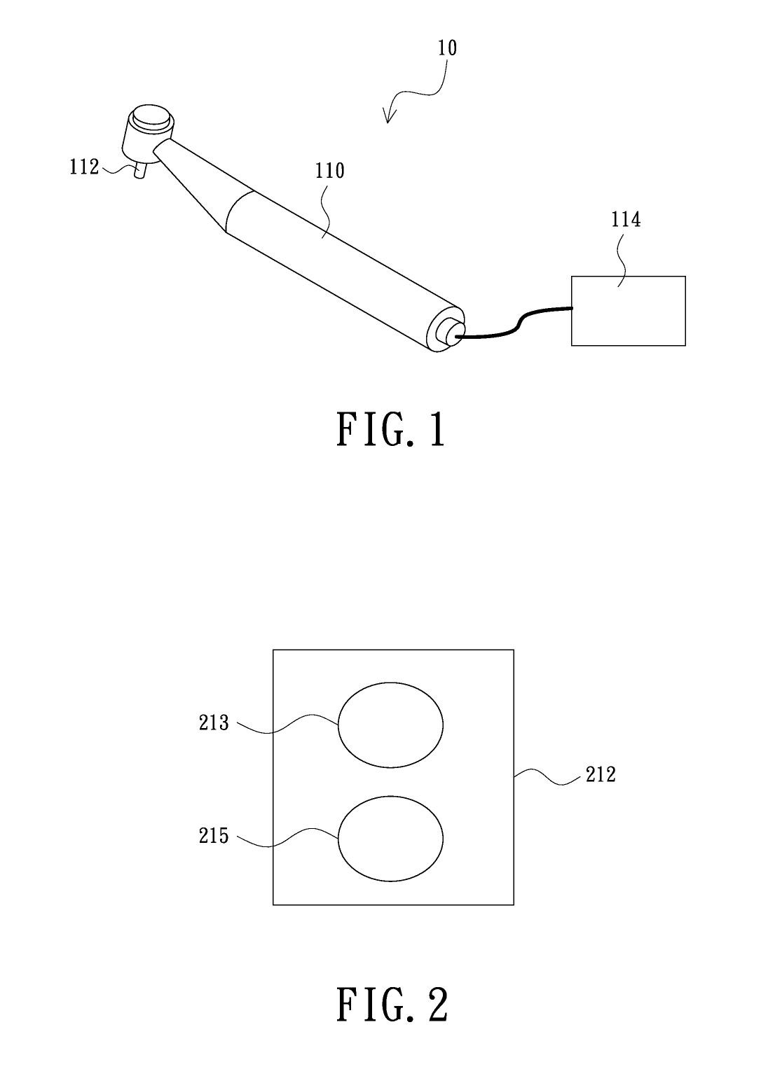

FIG. 1 is a schematic, structure view of a light therapy device of an embodiment of the present invention. Referring to FIG. 1, a light therapy device 10 includes a main body 110, a light-emitting portion 112 and a power supply unit 114. The light-emitting portion 112 is disposed on the main body 110. The light-emitting portion 112 has a first light source which can provide light with a specific wavelength and a specific energy. In the present embodiment, the first light source can comprise one or more light emitting diode. The first light source provides light with a wavelength ranged from 650 nanometer (nm) to 800 nm and with an energy ranged from 0.2 J/cm² to 10 J/cm². In preferred cases, the first light source provides light with a wavelength ranged from 650 nm to 700 nm and with an energy ranged from 3 J/cm² to 8 J/cm². The power supply unit 114 is electrically connected to the main body 110 and provides the light-emitting portion 112 with electric power. In the present embodiment, the light-emitting portion 112 of the main body 10 is used to irradiate teeth and periodontal cells, which can promote regeneration of teeth bone cells and gum tissues.

It is worth mentioning that, in other embodiments, the first light source can provide light with a wavelength ranged from 550 nm to 650 nm and with an energy ranged from 0.2 J/cm² to 10 J/cm². In preferred cases, the first light source provides light with a wavelength ranged from 560 nm to 630 nm and with an energy ranged from 3 J/cm² to 8 J/cm². Additionally, in other embodiments, the first light source can provide light with a wavelength ranged from 385 nm to 445 nm and with an energy ranged from 0.1 J/cm² to 10 J/cm². In preferred cases, the first light source provides light with a wavelength ranged from 390 nm to 420 nm and with an energy ranged from 0.2 J/cm² to 6 J/cm².

It should be noted that, in another embodiment, the first light source comprises one or more light emitting diode which can provide infrared radiation with a wavelength ranged from 800 nm to 950 nm and with an energy ranged from 0.01 J/cm² to 2 J/cm².

FIG. 2 is a schematic view of a light-emitting portion of a light therapy device of another embodiment of the present invention. In another embodiment of the present invention, except a first light source 213 described above, the light-emitting portion 212 further includes a second light source 215 which can provide another light with a specific wavelength and with a specific energy. Alternatively, the light-emitting portion 212 can include more than two light sources.

In the present embodiment, the second light source 215 can comprise one or more light emitting diode, but it is not limited by the present invention. In other embodiments, the light-emitting portion 212 may be a light emitting diode capable of emitting composite light, so as to provide a first light source and a second light source. The second light source 215 can provide light with a wavelength ranged from 650 nm to 800 nm and with an energy ranged from 10 J/cm² to 20 J/cm².

In other embodiments, the second light source can provide light with a wavelength ranged from 550 nm to 650 nm and with an energy ranged from 10 J/cm² to 20 J/cm². In addition, in other embodiments, the second light source can provide light with a wavelength ranged from 385 nm to 445 nm and with an energy ranged from 10 J/cm² to 20 J/cm². In the present embodiment, the second light source can inhibit the activity of periodontal bacteria (such as Helicobacter pylori), reduce oral bacteria and decrease inflammation phenomenon of periodontal tissues, so as to achieve a therapeutic effect of bacteriostasis.

In other embodiments of the present invention, the light therapy device further includes a photodynamic antimicrobial disposed on the main body. The photodynamic antimicrobial, for example, comprises Toluidine Blue O (TBO), porphyrins, porphyrin-derivatives, chlorine, chlorine-derivatives, 5-aminolevulinic acid (ALA), 3,6-bis(1-methyl-4-vinylpyridinium)carbazole diiodide (BMVC), MBVC-derivatives, methylene blue (MB), actinomycin, hypocrellin, hypocrellin-derivatives, phycocyanin, phycocyanin-derivative and so on. The photodynamic antimicrobial is used together with the light source having a suitable wavelength and energy, and teeth and periodontal tissues are stimulated by light, thereby decreasing a number and the activity of the periodontal bacteria (such as Helicobacter pylori).

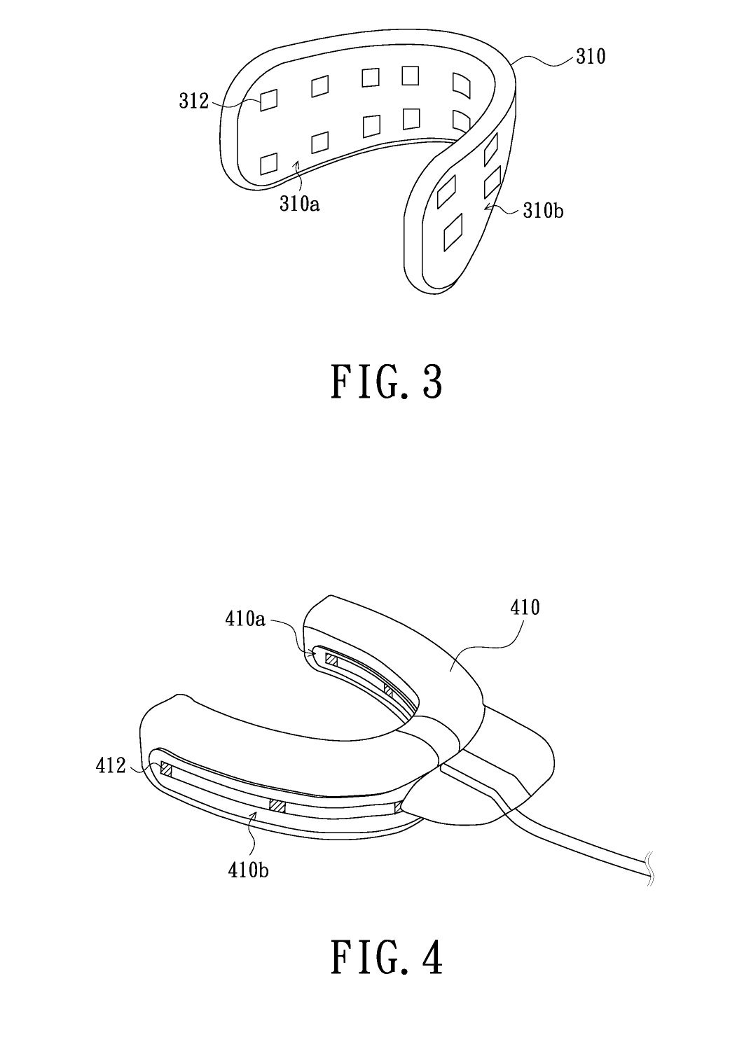

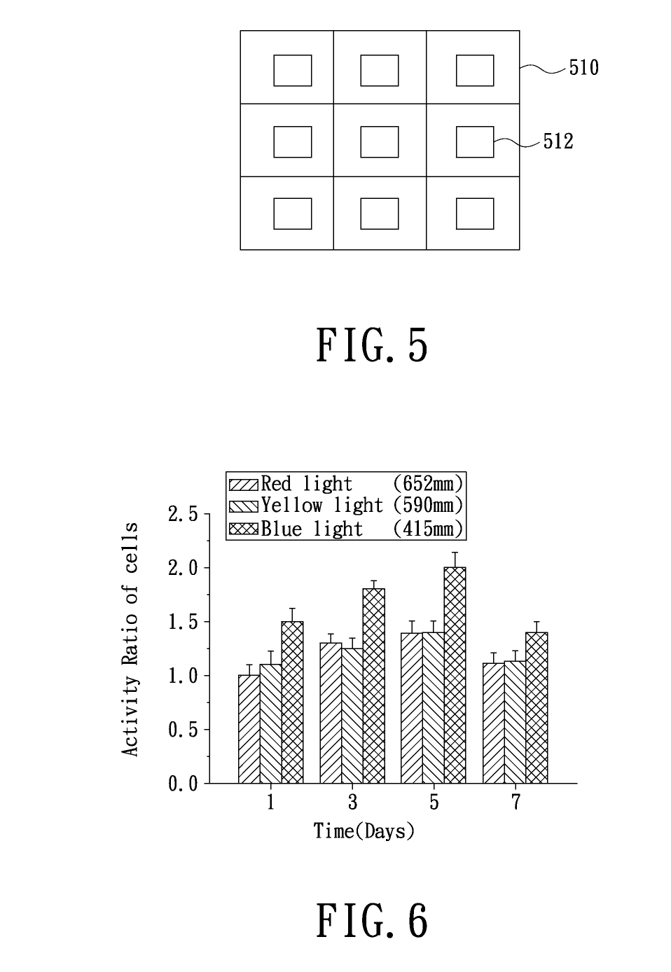

Referring to FIG. 1 further, in the present embodiment, a shape of the main body 110 has a long-handled structure, a user can hold the main body 110 with his/her hand and make the light-emitting portion 112 irradiate teeth and periodontal cells, thereby achieving a therapeutic effect. According to another embodiment, referring to FIG. 3, a main body 310 of a light therapy device can be U-shaped. The main body 310 has an inner surface 310a and an outer surface 310b opposite to the inner surface 310a. A plurality of light-emitting portions 312 are respectively disposed on the upper side and the lower side of the inner surface 310a and the outer surface 310b. A user can put the main body 310 into mouth and make the main body 310 attach to surfaces of teeth, which can comprehensively provide an irradiating function for teeth and gum tissues, thereby achieving a therapeutic effect. FIG. 4 is a structure view of a U-shaped main body of a light therapy device of another alternative embodiment. A main body 410 has an inner surface 410a and an outer surface 410b opposite to the inner surface 410a. A plurality of light-emitting portions 412 are respectively disposed on the middle area of the inner surface 410a and the outer surface 410b. According to another embodiment of the present invention, as shown in FIG. 5, a main body 510 of a light therapy device can be sheet structure, and a light-emitting portion 512 is disposed on the main body 510. The user can directly put the main body 510 into mouth, which can comprehensively provide an irradiating function for teeth and gum tissues, thereby achieving a therapeutic effect. Three kinds of shapes of the main body are disclosed above, however the present invention does not limit shapes of the main body, the shapes of the main body can be designed according to users' requirements.

Referring to FIG. 6, FIG. 6 is an experiment data based on activity changes of periodontal cells stimulated by light. An activity of cells can be tested via utilizing MTT analysis method which adopts living cell metabolites reductant. The living cell metabolites reductant can be 3-(4,5-cimethylthiaz ol-2-yl)-2,5-diphenyl tetrazolium bromide. The experiment is performed to test influence on periodontal cell mitochondrion stimulated by light, and then regeneration situation of periodontal cells is observed. In FIG. 6, light with three different wavelengths irradiates mediums of periodontal cell mitochondrion, changes of the activity of the mitochondrion are measured according to different irradiating days. The vertical axis in FIG. 6 is activity ratio of cells, which is an average value of the mitochondrion activity relative to a number of cells, and the ratio is an average value of light irradiating groups divided by control groups without light. The horizontal axis in FIG. 6 is light irradiating time (days). In the present experiment, light with three different wavelengths is respectively provided by a red light emitting diode having a wavelength of 652 nm, a yellow light emitting diode having a wavelength of 590 and a blue light emitting diode having a wavelength of 415 nm, and the energy of provided light are all 1 J/cm². As shown in FIG. 6, the activity of mitochondrion is obviously promoted after the third day of light irradiating, and this effect can continue to the seventh day. Therefore, periodontal cells are irradiated by light with appropriate wavelength and energy, which can promote the activity of the mitochondrion and generate more energy for the cells, and induce other physiological performance, thereby promoting growth and development of the bone cells.

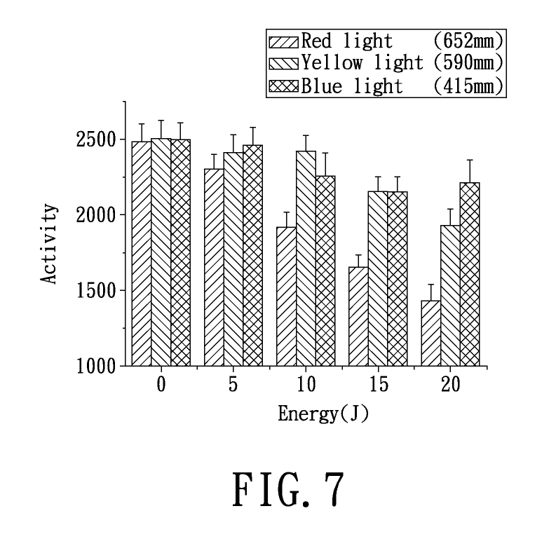

Referring to FIG. 7, FIG. 7 is an experiment data of activity changes of periodontal bacteria irradiated by light. The experiment is preformed to test influence on periodontal bacteria stimulated by light. Periodontal bacteria are irradiated by light with different wavelengths and different energy and the light is emitted by light emitting diode, and then activity changes of periodontal bacteria are detected. The vertical axis of FIG. 7 is activity of periodontal bacteria, and the horizontal axis of FIG. 7 is energy of light sources. A red light emitting diode having a wavelength of 652 nm, a yellow light emitting diode having a wavelength of 590 nm and a blue light emitting diode having a wavelength of 415 nm are used to make the experiment, and the light energy is ranged from 0 to 20 J/cm². As shown in FIG. 7, when energy of the red light emitting diode reaches 10 J/cm², the activity of bacteria is obviously inhibited. The yellow and blue light emitting diodes are also able to inhibit the activity of bacteria. In other experiments, if the blue light, the yellow light and together with the photodynamic antimicrobial, such as Toluidine Blue O (TBO), are used, the inhibitory effect of bacterial activity is more significant.

It is worth mentioning that, an experiment using a low-power light emitting diode discloses that, changes of temperature caused by light energy is in a scale which the cells can endure. Therefore, when the light emitting diode is used to stimulate the cells, a significant thermal effect will not be produced to affect the performance physiology of the cells.

In summary, in the light therapy device of the present invention, light with a specific wavelength and a specific energy is selected to irradiate teeth and periodontal cells, which can stimulate proliferation of bone cells, promote the activity of bone cells to accelerate regeneration of bone, and accelerate cell differentiation in order to promote generation of bone. Additionally, the light therapy device can also stimulate hyperplasia of gum cells, promote the activity of gum cells so as to accelerate regeneration of the gum, reduce amount of bacteria in mouth, and decrease inflammation of periodontal tissues. Therefore, the use of the light therapy device of the present invention for treating periodontal diseases, not only can decrease the damage to teeth and periodontal cells, but also can accelerate regeneration of teeth bone cells and gum tissues and inhibit bacteria, thereby increasing the therapeutic effect.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light therapy device, comprising:
a main body;
a light-emitting portion, disposed on the main body, the light-emitting portion having a first light source, the first light source providing light with a specific wavelength and with an energy ranged from 0.01 J/cm² to 10 J/cm²; and
a power supply unit, electrically connected to the main body, and configured for providing the light-emitting portion with electric power.

2. The light therapy device according to claim 1, wherein the first light source is a light emitting diode.

3. The light therapy device according to claim 1, wherein the first light source provides light with a wavelength ranged from 650 nm to 800 nm and with an energy ranged from 0.2 J/cm² to 10 J/cm².

4. The light therapy device according to claim 3, wherein the first light source provides light with a wavelength ranged from 650 nm to 700 nm and with an energy ranged from 3 J/cm² to 8 J/cm².

5. The light therapy device according to claim 1, wherein the first light source provides light with a wavelength ranged from 550 nm to 650 nm and with an energy ranged from 0.2 J/cm² to 10 J/cm².

6. The light therapy device according to claim 5, wherein the first light source provides light with a wavelength ranged from 560 nm to 630 nm and with an energy ranged from 3 J/cm² to 8 J/cm².

7. The light therapy device according to claim 1, wherein the first light source provides light with a wavelength ranged from 385 nm to 445 nm.

8. The light therapy device according to claim 7, wherein the first light source provides light with a wavelength ranged from 390 nm to 420 nm and with an energy ranged from 0.2 J/cm² to 6 J/cm².

9. The light therapy device according to claim 1, wherein the first light source provides infrared radiation with a wavelength ranged from 800 nm to 950 nm and with an energy ranged from 0.01 J/cm² to 2 J/cm².

10. The light therapy device according to claim 1, wherein the light-emitting portion further comprises a second light source, the second light source provides light with an energy ranged from 5 J/cm² to 20 J/cm².

11. The light therapy device according to claim 10, wherein the second light source is a light emitting diode.

12. The light therapy device according to claim 10, wherein the light-emitting portion is a light emitting diode capable of emitting composite light for providing the first light source and the second light source.

13. The light therapy device according to claim 10, wherein the second light source provides light with a wavelength ranged from 650 nm to 800 nm and with an energy ranged from 10 J/cm² to 20 J/cm².

14. The light therapy device according to claim 10, wherein the second light source provides light with a wavelength ranged from 550 nm to 650 nm.

15. The light therapy device according to claim 10, wherein the second light source provides light with a wavelength ranged from 385 nm to 445 nm.

16. The light therapy device according to claim 1, further comprising a photodynamic antimicrobial disposed on the main body.

17. The light therapy device according to claim 16, wherein the photodynamic antimicrobial comprises Toluidine Blue O (TBO), porphyrins, porphyrin-derivatives, chlorine, chlorine-derivatives, 5-aminolevulinic acid (ALA), 3,6-bis(1-methyl-4-vinylpyridinium)carbazole diiodide (BMVC), MBVC-derivatives, methylene blue (MB), actinomycin, hypocrellin, hypocrellin-derivatives, phycocyanin or phycocyanin-derivative.

18. The light therapy device according to claim 1, wherein the main body has a long-handled or sheet-shaped structure.

19. The light therapy device according to claim 1, wherein the main body is U-shaped and has an inner surface and an outer surface opposite to the inner surface, the light-emitting portion is disposed on the inner surface and the outer surface.
